(19) United States
(12) Patent Application Publication
(10) Pub. No.: US 2026/0233617 A1
(43) Pub. Date: Aug. 13, 2026

(54) METHOD AND DEVICE FOR PROVIDING COMPREHENSIVE ELECTRIC MOBILITY CONTROL SOLUTION

(71) Applicant: META MOBILITY INC., Gwangmyeong-si, Gyeonggi-do (KR)

(72) Inventor: Jiwon KIM, Ansan-si (KR)

(73) Assignee: META MOBILITY INC., Gwangmyeong-si, Gyeonggi-do (KR)

(21) Appl. No.: 19/158,953

(22) PCT Filed: Feb. 21, 2024
(86) PCT No.: PCT/KR2024/002280

§ 371 Date: Aug. 22, 2025

(30) Foreign Application Priority Data
Feb. 22, 2023 (KR) 10-2023-0023395
Nov. 1, 2023 (KR) 10-2023-0148876

(51) Int. Cl. B60L 3/12; G06F 8/65; G07C 5/00; G07C 5/08

(52) U.S. Cl. CPC B60L 3/12; G06F 8/65; G07C 5/008; G07C 5/0816

(57) ABSTRACT

The present disclosure relates to a method for providing a comprehensive electric mobility control solution. The method includes: obtaining electric mobility-related information from fleets; generating, on the basis of the electric mobility-related information, fleet-related information regarding the fleets; and transmitting the fleet-related information to the fleets, wherein, on the basis of a web or application, the fleet-related information is transmitted to each fleet, and each fleet displays the received fleet-related information through dashboards or display units. Therefore, it is possible to carry out remote diagnostics on electric mobility units and to manage an issue event of each electric mobility unit so as to manage multiple electric mobility units that can be remotely diagnosed, and it is possible to carry out diagnostics on each electric mobility unit and ultimately to evaluate the value of each electric mobility unit.

### TECHNICAL FIELD

The present invention relates to a method and device for providing a comprehensive electric mobility control solution. More specifically, the present invention relates to a method and device for providing a comprehensive electric mobility control solution which manages a plurality of electric mobility units based on an issue data-based remote diagnosis solution of key devices included in mobility using electricity.

### BACKGROUND ART

Electric vehicle sales have been growing exponentially in recent years, and this growth is expected to continue in the future. Many parts used in conventional internal combustion engine vehicles have disappeared from electric vehicles, and as a result, a method of diagnosing electric vehicles may also differ from that of conventional internal combustion engine vehicles.

Diagnosis of electric vehicles is performed through on-board diagnostics (OBD) and may be performed using information received from the outside through over-the-air (OTA) software or firmware. However, conventional electric vehicle diagnosis is battery-centric diagnosis, and data is generally collected through a single channel relying on information of each manufacturer.

In addition, since the current preprocessing speed for electric vehicle diagnosis is relatively low, and connectivity is not high, there may be limitations in electric vehicle diagnosis, and there is a problem that it is impossible to diagnose electric vehicles in real time.

### RELATED ART LITERATURE

### Patent Document

(Patent Document 0001) Korean Laid-Open Patent Publication No. 10-2023-0099574

### DETAILED DESCRIPTION OF INVENTION

### Technical Problem

Accordingly, an object of the present invention is to provide a method and device for providing a comprehensive electric mobility control solution, which are capable of carrying out remote diagnostics on electric mobility units and managing an issue event of each electric mobility unit so as to manage multiple electric mobility units that can be remotely diagnosed, on the basis of the monitoring of key devices of the electric mobility unit including an electric vehicle.

Another object of the present invention is to provide a method and device for providing a comprehensive electric mobility control solution capable of carrying out diagnostics on each electric mobility unit and ultimately evaluating the value of each electric mobility unit on the basis of integrated management information of the multiple electric mobility units.

### Technical Solution

The above-described objects are achieved by a method of providing a comprehensive electric mobility control solution, which includes: obtaining electric mobility-related information from a plurality of fleets; generating, on the basis of the electric mobility-related information, fleet-related information regarding the plurality of fleets; and transmitting the fleet-related information to each of the plurality of fleets, in which, on the basis of a web or application, the fleet-related information is transmitted to each of the plurality of fleets, and each of the plurality of fleets displays the received fleet-related information through a dashboard or display unit

The method may further include: generating a fleet report for each of the plurality of fleets; transmitting the generated fleet report to an original equipment manufacturer (OEM) server; obtaining over-the-air (OTA) update information from the OEM server; and transmitting the OTA update information to each of the plurality of fleets, and the plurality of fleets may update OTA software included therein based on the OTA update information.

The fleet-related information may include information regarding each of the plurality of fleets and information regarding all the plurality of fleets, the information regarding each of the plurality of fleets may include current location information of the fleet, driving information of the fleet, issue event information of the fleet, fleet component-related information, and fleet current value information, and the information regarding all the plurality of fleets may include distribution information of the fleets, operational information of the fleets, and management information of the fleets.

The fleet-related information generated based on the electric mobility-related information may further include key device information, component-related information, and fleet current value information regarding each of the plurality of fleets, and driving of each of the plurality of fleets may be controlled based on the key device information, the component-related information, and the fleet current value information regarding each of the plurality of fleets.

The fleet-related information generated based on the electric mobility-related information may be generated in consideration of a type of each of the plurality of fleets.

Each of the plurality of fleets may obtain data from a data scanning device of each of one or more fleet key devices, obtain selected compressed data through a database (DB) constructed from the data, transmit the selected compressed data and on-board diagnostics (OBD)-based data to a cloud, extract issue data through issue modeling based on the electric mobility-related information, which includes the selected compressed data and the OBD-based data, set an issue event through the extracted issue data, and provide a real-time notification and warning based on the issue event.

The fleet key device may include at least one of an integrated electric power control unit (EPCU), an on-board charger (OBC), a drive motor, a deceleration device, and a battery management system (BMS), and the data scanning device may include at least one of a sensor, an edge computing module, and a communication module.

The data obtained from the data scanning device of each fleet key device may include at least one of power, current, voltage, vibration, noise, and other data, and the selected compressed data may be generated by comparing a waveform and trimmed data obtained from the data with the constructed DB.

One or more issue events may be set through the issue modeling based on the extracted issue data, the issue events may include a first threshold value for issue event triggering, the issue events may provide the real-time notification and warning for the issue events when a difference value between real-time electric mobility-related information obtained in real time from the cloud and the extracted issue event is compared with the first threshold value and a comparison result is greater than the first threshold value.

Meanwhile, the above-described objects are also achieved by a device for providing a comprehensive electric mobility control solution, which includes: a transceiver that transmits and receives data; a memory that stores the data; and a control unit that controls the transceiver and the memory, in which the control unit obtains electric mobility-related information from a plurality of fleets, generates, on the basis of the electric mobility-related information, fleet-related information regarding the plurality of fleets; and transmits the fleet-related information to each of the plurality of fleets, and the fleet-related information is transmitted to each of the plurality of fleets on the basis of a web or application, and each of the plurality of fleets displays the received fleet-related information through a dashboard or display unit.

### Advantageous Effects

According to a method and device for providing the comprehensive electric mobility control solution according to the present invention, it is possible to carry out remote diagnostics on electric mobility units and to manage an issue event of each electric mobility unit so as to manage multiple electric mobility units that can be remotely diagnosed, on the basis of the monitoring of key devices of the electric mobility unit including an electric vehicle.

In addition, according to the method and device for providing the comprehensive electric mobility control solution according to the present invention, it is possible to carry out diagnostics on each electric mobility unit and to ultimately evaluate the value of each electric mobility unit on the basis of integrated management information of the multiple electric mobility units.

### BRIEF DESCRIPTION OF DRAWINGS

FIG. 1 is a diagram illustrating an example of an operating environment of a system according to an embodiment of the present invention.

FIG. 2 is a block diagram illustrating an internal configuration of a computing device according to an embodiment of the present invention.

FIG. 3A is a diagram illustrating key devices of an electric mobility unit and a method of acquiring electric mobility-related data based on the key device according to an embodiment of the present invention.

FIG. 3B is a diagram illustrating key devices of an electric mobility unit and a method of acquiring electric mobility-related data based on the key devices according to an embodiment of the present invention.

FIG. 4A is a diagram illustrating a method of collecting data through hardware mounted on key devices according to an embodiment of the present invention.

FIG. 4B is a diagram illustrating a method of transmitting collected data to the outside according to an embodiment of the present invention.

FIG. 5A is a diagram illustrating a method of performing data analysis according to an embodiment of the present invention.

FIG. 5B is a diagram illustrating a method of performing data analysis according to an embodiment of the present invention.

FIG. 6 is a diagram illustrating a method of providing a comprehensive electric mobility control solution.

FIG. 7A is a diagram illustrating a method for providing issue event-related information of each electric mobility unit based on a comprehensive electric mobility control system according to an embodiment of the present invention.

FIG. 7B is a diagram illustrating a method of providing issue event-related information of each electric mobility unit based on a comprehensive electric mobility control system according to an embodiment of the present invention.

FIG. 8A is a diagram illustrating data exchange between a comprehensive electric mobility control system and an original equipment manufacturer (OEM) server according to an embodiment of the present invention.

FIG. 8B is a diagram illustrating a method of managing each electric vehicle based on a comprehensive electric mobility control system according to an embodiment of the present disclosure.

FIG. 9 is a diagram illustrating a method of managing an electric vehicle by a comprehensive electric mobility control system based on an electric vehicle type according to an embodiment of the present invention.

FIG. 10 is a flowchart illustrating a method of providing a comprehensive electric mobility control solution according to an embodiment of the present invention.

### BEST MODE

In describing embodiments of the present invention, when it is determined that a specific description of a known configuration or function may obscure the gist of the embodiments of the present invention, a detailed description thereof will be omitted. In addition, parts unrelated to the description of the embodiments of the present invention have been omitted in the drawings, and similar parts have been given similar drawing reference numerals.

In the embodiments of the present invention, when a component is referred to as being “connected,” “coupled,” or “joined” to another component, this may include not only a direct connection relationship, but also an indirect connection relationship in which another component exists in between. In addition, when a component is referred to as “including” or “having” another component, this does not exclude the other component unless specifically stated otherwise but means that another component may be included.

In the embodiments of the present invention, the terms such as first, second, and the like are used only for the purpose of distinguishing one component from another component, and do not limit the order or importance of the components unless specifically stated. Therefore, within the scope of the embodiments of the present invention, a first component in an embodiment may be referred to as a second component in another embodiment, and similarly, a second component in an embodiment may be referred to as a first component in another embodiment.

In the embodiments of the present invention, the components that are distinguished from each other are intended to clearly describe their respective features, and do not necessarily mean that the components are separated. That is, a plurality of components may be integrated to form a single hardware or software unit, or a single component may be distributed to form a plurality of hardware or software units. Therefore, even if not mentioned separately, such integrated or distributed embodiments are also included in the scope of the embodiments of the present invention.

In the present invention, a network may be a concept that includes both wired and wireless networks. In this case, the network may mean a communication network in which data exchange between devices and systems and devices can be performed but is not limited to a specific network.

The embodiments described in the present invention may have aspects that are entirely hardware, partially hardware and partially software, or entirely software. In the present invention, the terms “unit,” “device,” “system,” and the like refer to a computer-related entity, such as hardware, a combination of hardware and software, or software. For example, in the present invention, a unit, module, device, system, and the like may be a running process, a processor, an object, an executable, a thread of execution, a program, and/or a computer, but is not limited thereto. For example, both an application running on a computer and the computer may correspond to a unit, module, device, system, and the like of the present invention.

In addition, in the present invention, the device may be a mobile device such as a smartphone, a tablet PC, a wearable device, and a head mounted display (HMD), as well as a fixed device such as a PC or a home appliance with a display function. In addition, as an example, the device may be an in-vehicle cluster or an Internet of Things (IoT) device. That is, in the present invention, the device may refer to devices capable of operating an application but is not limited to a specific type. Hereinafter, for convenience of description, a device on which an application operates is referred to as a device.

In the present invention, the communication method of the network is not limited, and connections between components may not be connected in the same network method. The network may include not only a communication method utilizing a communication network (e.g., a mobile communication network, a wired Internet, a wireless Internet, a broadcasting network, a satellite network, etc.), but also short-range wireless communication between devices. For example, the network may include all communication methods that allow objects to network with each other, but is not limited to wired communication, wireless communication, third generation (3G), fourth generation (4G), fifth generation (5G), or other communication methods. For example, the wired and/or wireless network may refer to a communication network by one or more communication methods selected from a group consisting of a local area area network (LAN), a metropolitan area network (MAN), a global system for mobile network (GSM), an enhanced data GSM environment (EDGE), high speed downlink packet access (HSDPA), wideband code division multiple access (W-CDMA), code division multiple access (CDMA), time division multiple access (TDMA), Bluetooth, ZigBee, Wi-Fi, Voice over Internet Protocol (VoIP), LTE Advanced, IEEE802.16m, WirelessMAN-Advanced, HSPA+, 3rd Generation Partnership Project (3GPP) long term evolution (LTE), Mobile WiMAX (IEEE) 802.16e), UMB (formerly EV-DO Rev. C), Flash-orthogonal frequency division multiplexing (OFDM), iBurst and mobile broadband wireless access (MBWA) (IEEE 802.20) systems, high performance radio metropolitan area network (HIPERMAN), beam-division multiple access (BDMA), World Interoperability for Microwave Access (Wi-MAX), and ultrasonic communication, but not limited thereto.

The components described in the various embodiments do not necessarily mean essential components, and some components may be optional components. Accordingly, embodiments including a subset of the components described in the embodiments are also included in the scope of embodiments of the present invention. In addition, embodiments that include other components in addition to the components described in the various embodiments are also included within the scope of embodiments of the present invention.

Hereinafter, embodiments of the present invention will be described in detail with reference to the accompanying drawings.

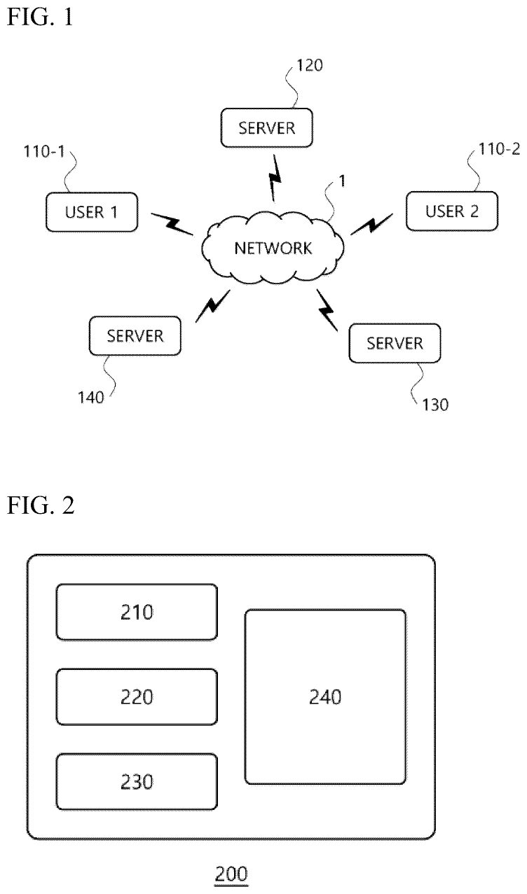

FIG. 1 is a diagram illustrating an example of an operating environment of a system according to an embodiment of the present invention. Referring to FIG. 1, one or more user devices 110-1 and 110-2 and one or more servers 120, 130, and 140 are connected to one another through a network 1. FIG. 1 is an example for describing the invention, and the number of user devices or servers is not limited to that shown in FIG. 1.

The one or more user devices 110-1 and 110-2 may be fixed terminals or mobile terminals implemented as computer systems. The one or more user devices 110-1 and 110-2 may include, for example, a smart phone, a mobile phone, a navigation device, a computer, a laptop computer, a digital-broadcasting terminal, a personal digital assistant (PDA), a portable multimedia player (PMP), a tablet PC, a game console, a wearable device, an IoT device, a virtual reality (VR) device, an augmented reality (AR) device, and the like. As an example, in the embodiments, the user device 110 may mean one of various physical computer systems that may communicate with other servers 120 to 140 through the network 1 using substantially wireless or wired communication methods.

Each server may be implemented as a computer device or a plurality of computer devices that communicate with one or more user devices 110-1 and 110-2 through the network 1 to provide instructions, code, files, content, services, and the like. For example, the server may be a system that provides each service to one or more user devices 110-1 and 110-2 connected through the network 1. As a more specific example, the server may provide a service (e.g., providing information or the like) intended by an application as a computer program installed and run on one or more user devices 110-1 and 110-2 to one or more user devices 110-1 and 110-2 through the application. As another example, the server may distribute a file for installing and running the above-described application to one or more user devices 110-1 and 110-2 and receive user input information to provide a corresponding service.

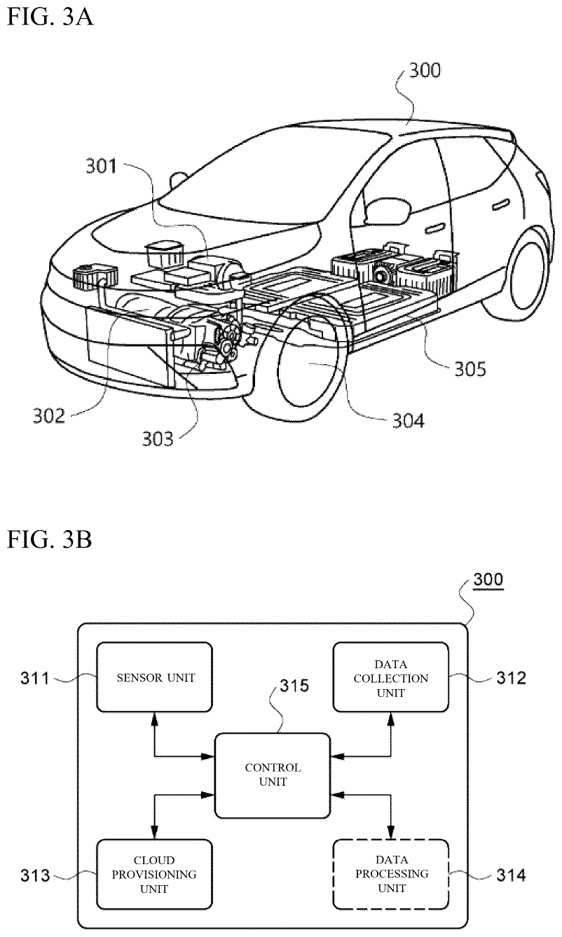

FIG. 2 is a block diagram illustrating an internal configuration of a computing device 200 according to an embodiment of the present invention. Such a computing device 200 may be applied to one or more user devices 110-1 and 110-2 or the servers 120 to 140 described above with reference to FIG. 1, and the devices and servers may have the same or similar internal configuration by adding or excluding some components.

Referring to FIG. 2, the computing device 200 may include a memory 210, a processor 220, a communication module 230, and a transceiver 240. The memory 210 is a non-transitory computer-readable storage medium and may include a permanent mass storage device such as a random access memory (RAM), a read only memory (ROM), a disk drive, a solid state drive (SSD), a flash memory, and the like. Here, the permanent mass storage device, such as the ROM, the SSD, the flash memory, the disk drive, and the like may be included in the device or server described above as a permanent storage device distinct from the memory 210. In addition, in the memory 210, an operating system and at least one program code (e.g., code for a browser installed and running on the user device 110 or the like, or an application installed on the user device 110 or the like to provide a specific service) may be stored. These software components may be loaded from a computer-readable recording medium separate from the memory 210. Such a separate computer-readable recording medium may include a computer-readable recording medium such as a floppy drive, a disk, a tape, a digital versatile disc DVD/compact disc read-only memory (CD-ROM) drive, a memory card, and the like.

In another embodiment, the software components may be loaded into the memory 210 through the communication module 230 rather than a computer-readable recording medium. For example, at least one program may be loaded into the memory 210 based on a computer program (e.g., the above-described application) installed by files provided through the network 1 by developers or a file distribution system (e.g., the above-described server) that distributes an installation file of the application.

The processor 220 may be configured to process instructions of the computer program by performing basic arithmetic, logic, and input/output operations. The instructions may be provided to the processor 220 through the memory 210 or by the communication module 230. For example, the processor 220 may be configured to execute instructions received according to program code stored in a recording device such as the memory 210.

The communication module 230 may provide a function for the user device 110 and the servers 120 to 140 to communicate with each other through the network 1, and may provide a function for each of the device 110 and/or the servers 120 to 140 to communicate with other electronic devices.

The transceiver 240 may be a means for interfacing with an external input/output device (not shown). For example, the external input device may include a device such as a keyboard, a mouse, a microphone, a camera, and the like, and the external output device may include a device such as a display, a speaker, a haptic feedback device, and the like. As another example, the transceiver 240 may be a means for interfacing with a device in which a function for input and output is integrated into one, such as a touch screen.

Further, in other embodiments, the computing device 200 may include more components than the components of FIG. 2 depending on the nature of the device to which the computing device 200 is applied. For example, when the computing device 200 is applied to the user device 110, the computing device 200 may further include other components such as a transceiver, a global positioning system (GPS) module, a camera, various sensors, a database, and the like. As a more specific example, when the user device is a smartphone, the computing device 200 may be implemented to further include various components that are generally included in a smartphone, such as an acceleration sensor, a gyro sensor, a camera module, various physical buttons, buttons using a touch panel, input/output ports, and a vibrator for vibration.

As an example, an electric mobility (or an electric vehicle or vehicle) described below may be the computing device 200 of FIG. 2. That is, the electric mobility unit may communicate with another device or a server through the network of FIG. 1 as one computing device 200. As another example, each key device in the electric mobility unit may be one computing device 200. That is, each key device in the electric vehicle may collect data and transmit the data to another device or a control unit of the electric mobility unit. In addition, the device, in which the software, the application, and other programs are operated, for providing an electric mobility remote diagnosis solution may be the computing device 200. That is, each of the devices described below may include the respective components of the computing device 200 of FIG. 2 and perform data transmission/reception through the network of FIG. 1, but is not limited thereto.

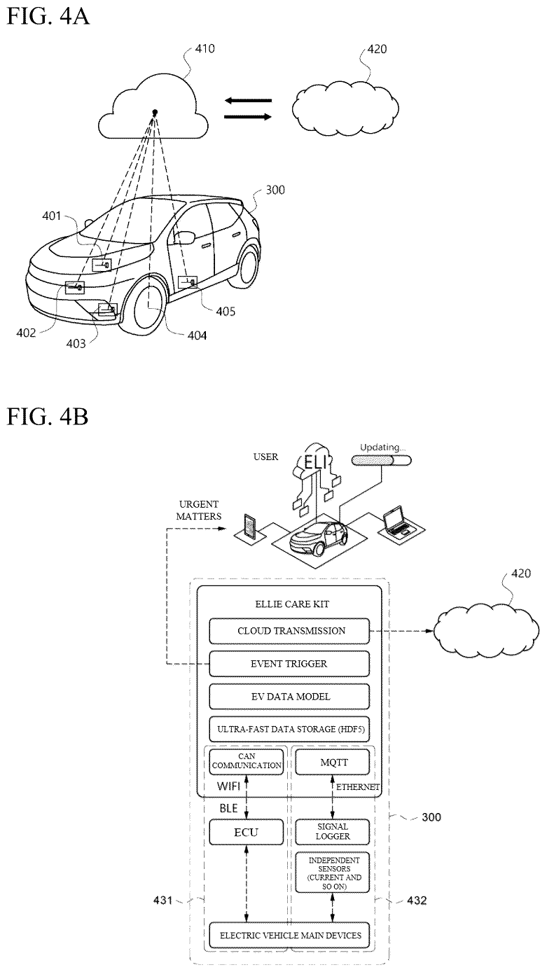

Hereinafter, a method and device for providing a comprehensive control solution for the electric mobility unit based on the above description will be described. In the following, an electric vehicle will be described as an example of the electric mobility unit for convenience, and the comprehensive control solution according to the present invention may be applied to all kinds of mobility units using electricity. FIGS. 3A and 3B are diagrams illustrating key devices of an electric vehicle and a method of acquiring electric vehicle-related data based on the key devices, in an embodiment of the present invention.

Referring to FIG. 3A, an electric vehicle 300 may include an integrated electric power control unit (EPCU) 301, an on-board charger (OBC) 302, a drive motor 303, a deceleration device 304, and a battery management system 305. In addition, the electric vehicle 300 may further include other devices other than the above-described devices but is not limited thereto. As an example, the EPCU 301 may further include a motor control unit (MCU) that controls the speed and torque of a motor, a low voltage DC-DC converter (LDC) that changes a high voltage to a low voltage, and a vehicle control unit (VCU). As an example, the MCU may serve to control the torque and speed of the motor in the process of applying the DC-charged battery electricity to a three-phase AC motor. In addition, the LDC may serve to change the high voltage of the battery to a low voltage, thereby supplying power to each device. In addition, the VCU may be configured to control driver driving, battery monitoring, and other vehicle functions. The EPCU 301 may control the electric vehicle 300 based on the above-described configurations. In addition, the OBC 302 may be configured to control slow charging of the electric vehicle 300 using a battery charger installed inside the electric vehicle. In addition, the drive motor 303 may be configured to perform the same role as an engine of an internal combustion engine vehicle and control driving of the electric vehicle 300. In addition, the deceleration device 304 may be configured to decelerate the number of turns of wheels in order to transmit power to the wheels in consideration of the characteristics of the motor. In addition, the BMS 305 may also be a battery management system that monitors the electric vehicle battery and monitor a current, a voltage, a temperature, and other characteristics of the battery.

As an example, the electric vehicle 300 may be a vehicle that is driven based on electric power differently from the internal combustion engine vehicle, and the EPCU 301, OBC 302, driving motor 303, deceleration device 304, and BMS 305 described above may be controlled to enable vehicle driving. That is, the EPCU 301, the OBC 302, the drive motor 303, the deceleration device 304, and the BMS 305 may be key devices of the electric vehicle 300. However, it is not limited thereto, and other devices may be further included in the electric vehicle 300.

Here, as an example, the diagnosis for the electric vehicle may be performed through data collected through a single channel by reflecting each manufacturer's information based on the OBD. However, as described above, since data is collected by reflecting each manufacturer's information based on the OBD, there are limitations in collecting data, and since it is based on the single channel and the preprocessing speed is slow, there may be limitations in detecting an abnormality or issue occurring in real time. Considering the matters described above, it may be necessary for the electric vehicle 300 to perform an operation of securing dual data for the EPCU 301, the OBC 302, the drive motor 303, the deceleration device 304, and the BMS 305 as the key devices together with the above-described diagnosis process, and performing diagnosis based on the dual data. That is, the comprehensive electric mobility control solution according to an embodiment of the present invention may collect data through separate channels other than the OBD for the EPCU 301, the OBC 302, the drive motor 303, the deceleration device 304, and the BMS 305, and improve the data processing speed through the edge computing and communication technology to enable the preprocessing operation to be performed quickly. Through this, the comprehensive electric mobility control solution according to the present invention may improve the collection and storage speed of data, and accordingly, real-time event processing may be possible.

As an example, referring to FIG. 3B, for the above-described comprehensive electric mobility control solution, the electric vehicle 300 may include a sensor unit 311, a data collection unit 312, a cloud provisioning unit 313, a data processing unit 314, and a control unit 315. As an example, each configuration of FIG. 3B may be a logical configuration based on each function and perform the above-described operations in different devices in the electric vehicle 300, but is not limited to a specific form.

As a specific example, the sensor unit 311 may be included in each of the EPCU 301, the OBC 302, the drive motor 303, the deceleration device 304, and the BMS 305 as the above-described key devices. The sensor unit 311 may be configured to acquire data through an individual sensor separately from the above-described OBD. As an example, the sensor unit 311 may sense power, current, voltage, vibration, temperature, humidity, noise, and other data, but is not limited to a specific form. Here, the sensor unit 311 may be installed separately from the OBD to acquire individual data. Thereafter, the data collection unit 312 may receive the collected data from the sensor unit 311. As an example, the data collection unit 312 may acquire data collected through the sensor unit 311 attached to each of the key devices through edge computing or other communication technologies. The data collection unit 312 may perform ultra-high-speed data collection and perform Ethernet-based data transmission. Through this, the data collected by the sensor unit 311 may be quickly acquired and stored.

Thereafter, the cloud provisioning unit 313 may provide the stored data to a cloud. For example, the cloud provisioning unit 313 may provide the stored data to the outside through an Internet Protocol (IP)-based web service, or may operate in conjunction with the cloud. As another example, the cloud provisioning unit 313 may support the LTE, 5G, Wi-Fi, and other communications, and may also share data externally based on this. A cloud service that is usable in the present invention may be Amazon Efficient Web Services (AWS) of Amazon Technologies, but is not limited thereto.

Thereafter, the data processing unit 314 may perform a data preprocessing operation based on cloud-based data provided to the cloud. Here, for example, the data processing unit 314 performing the data preprocessing operation may be present inside the electric vehicle 300 and configured to directly process the stored data. As another example, the data processing unit 314 may be present outside the electric vehicle 300 and configured to acquire cloud-based data and process the data, but is not limited to a specific form. As an example, the data processing unit 314 may perform big data analysis and artificial intelligence (AI) data modeling on data collected and acquired through the sensor unit 311 with cloud-based data, and extract issue data. In addition, the data processing unit 314 may set an issue event based on issue data. The data processing unit 314 may perform spatial information-based data modeling and support data visualization through an application programming interface (API). In addition, the data processing unit 314 may monitor the issue event and enable the electric vehicle 300 to be controlled based on a critical issue, which will be described below. In addition, the data processing unit 314 may generate an AI model or another visualization model to enable the electric vehicle 300 to be managed.

The control unit 315 controls the sensor unit 311, the data collection unit 312, the cloud provisioning unit 313, and the data processing unit 314 described above. As an example, the control unit 315 may be a logical configuration for controlling the above-described configurations, but is not limited to a specific form. As a specific example, the control unit 315 may be implemented in the above-described VCU or may be implemented based on another device, but is not limited to a specific form.

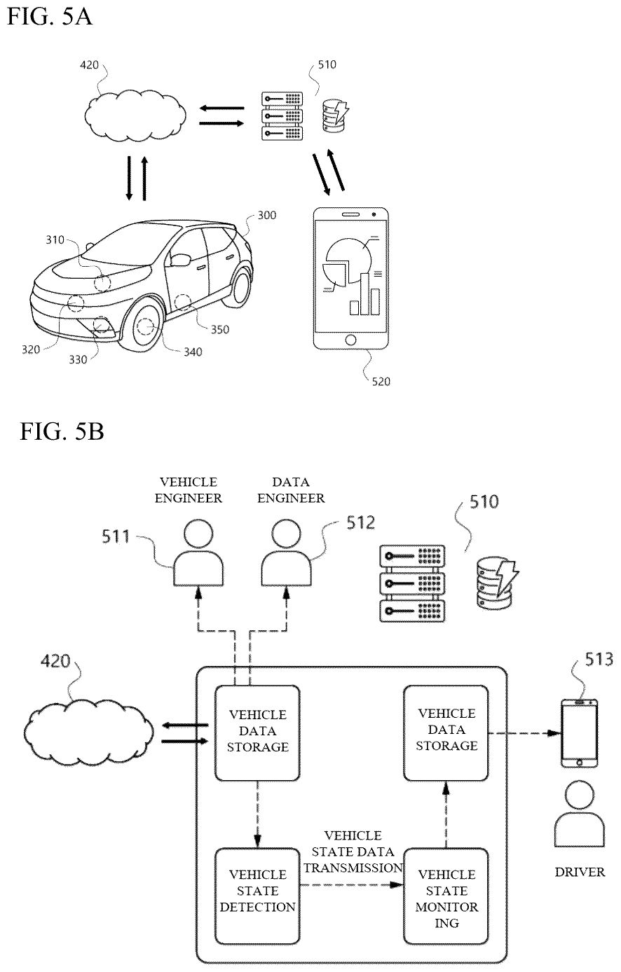

FIGS. 4A and 4B are diagrams illustrating a method of collecting data through hardware mounted on the key devices according to an embodiment of the present invention. Referring to FIG. 4A, hardware may be mounted on each key device to acquire current, voltage, power, temperature, humidity, vibration, noise, and other waveform data from the EPCU 301, the OBC 302, the drive motor 303, the deceleration device 304, and the BMS 305, which are the key devices of the electric vehicle 300. As a specific example, hardware devices 401, 402, 403, 404, and 405 may be respectively included in the EPCU 301, the OBC 302, the drive motor 303, the deceleration device 304, and the BMS 305. Here, the hardware devices 401, 402, 403, 404, and 405 may be devices based on the computing device 200 of FIG. 2, but are not limited thereto. As an example, the hardware devices 401, 402, 403, 404, and 405 may be devices in which data loggers, edge computing, and communication modules are combined, and based on this, may perform ultra-high-speed data transmission and reception. As an example, the hardware devices 401, 402, 403, 404, and 405 may acquire data based on signal logging, and may transmit the acquired data to another device through the edge computing and communication module. Here, ultra-high-speed data transmission and reception may be performed, and the ultra-high-speed data transmission and reception may be at a speed of 50 μs, i.e., 20,000 packets per second, but is not limited thereto. That is, each of the hardware devices 401, 402, 403, 404, and 405 may include a data logger function based on signal logging to the sensor unit 311 described above and transmit data collected through the edge computing and communication module to the data collection unit 312. Here, the hardware devices 401, 402, 403, 404, and 405 may be set separately from the OBD and separately collect and transmit data. Thereafter, the collected data may be transmitted to a data storage device 410, and the corresponding data may be transmitted to a cloud 420 again. As an example, the collected data may be compressed into selected data based on time-stamp, format conversion, classification, trimming, and other processing, and the selected compressed data may be transmitted to the cloud 420.

As a specific example, a database (DB) may be constructed and processed for compression of the selected data of the collected data. Here, the DB may be constructed from data associated with each of the key devices based on information, which is collected manufacturer's information collected based on the OBD and edge computing, but is not limited thereto. In addition, the DB may set an IP for a signal logger and reflect a scale for the signal logger and a setting for the sensor data. Thereafter, a data waveform may be scanned based on data acquired from the sensor unit 311, and data trimming in which an extreme value is excluded may be performed to generate selected compressed data. In the above-described process, values stored in the DB may be compared with the collected data. That is, the compression of the selected data for the collected data based on the constructed DB may be performed. As an example, the data waveform for the collected data may be compared with the waveform in the DB, and meaningful data may be extracted and compressed into selected data and then transmitted to the cloud 420.

In addition, as an example, data based on the existing OBD may be transmitted to the cloud 420. Referring to FIG. 4B, current, voltage, power, temperature, humidity, vibration, noise, and other waveform data may be acquired from the EPCU 301, the OBC 302, the drive motor 303, the deceleration device 304, and the BMS 305 as the key devices of the electric vehicle 300, and transmitted based on Ethernet, as described above (S 432).

In addition, for the key devices of the electric vehicle, OBD data may be transmitted through CAN communication based on Bluetooth Low Energy (BLE) or Wi-Fi based on an electric control unit (ECU) (S431). That is, the electric vehicle 300 may acquire existing diagnostic data based on the OBD and data that is subjected to an operation separately from this. Here, the acquired data may be compressed as selected data based on the above description and then transmitted to the cloud 420. In addition, an issue event may be monitored based on the acquired data and information may be transmitted to the outside. As a specific example, when an emergency situation is detected as an issue event based on OBD-based data and separately acquired data, the electric vehicle may transmit the corresponding information to a driver, a control center, and other external devices, but is not limited to a specific form. The cloud 420 may acquire data individually acquired based on edge computing and existing OBD-based data and monitor the issue event by using these types of data.

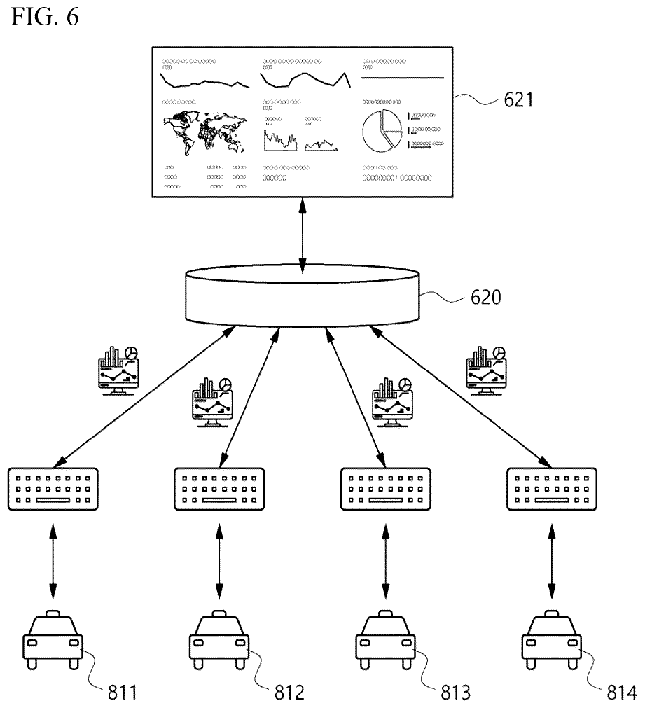

FIGS. 5A and 5B are diagrams illustrating a method of performing data analysis according to an embodiment of the present invention. Referring to FIG. 5A, when data for the EPCU 301, the OBC 302, the drive motor 303, the deceleration device 304, and the BMS 305 as the key devices of the electric vehicle 300 is transmitted to the cloud 420, big data analysis and issue modeling operations may be performed based on the transmitted data. Here, the cloud 420 may transmit the collected data to an issue modeling server 510. As an example, the collected data may be selected compressed data based on the DB. The issue modeling server 510 may be a server that extracts a plurality of pieces of issue data modeled through big data analysis based on the selected compressed data, but is not limited to a specific name.

More specifically, referring to FIG. 5B, the issue modeling server 510 may acquire the selected compressed data from the cloud 420. Here, the selected compressed data may be data generated based on the DB as information related to the key devices of the electric vehicle 300. In addition, the cloud 420 may further acquire the OBD-based data, but is not limited to a specific embodiment.

As an example, in the following description, data including the above-described selected compressed data and OBD-based data will be described as electric vehicle-related data for convenience of description. However, this is only for convenience of description, but is not limited thereto. The issue modeling server 510 may perform big data analysis on the electric vehicle-related data based on its own algorithm and store information obtained through the big data analysis. As an example, the stored electric vehicle-related data may also be transmitted to devices corresponding to a vehicle engineer 511 and a data engineer 512, but is not limited to a specific form.

As an example, the issue modeling server 510 may perform big data analysis through an issue modeling algorithm based on the electric vehicle-related data and extract one or more issue types of data. Here, the issue data may be data on issues related to the failure and diagnosis of the electric vehicle and set in consideration of a relationship between the key devices of the electric vehicle. As a specific example, the issue data may be set based on a combination of data for each of the EPCU 301, the OBC 302, the drive motor 303, the deceleration device 304, and the BMS 305 as the key devices of the electric vehicle 300. As an example, a plurality of pieces of issue data may be extracted based on a combination of pieces of data, such as issue data considering data of the drive motor 303 and the deceleration device 304, and issue data considering data of the EPCU 301, the OBC 302, and the BMS 305, but is not limited to a specific form.

At least one piece of extracted issue data may be compared to the electric vehicle-related data which is acquired in real time from the electric vehicle 300 and is transmitted to the cloud 420, and an issue event may be set based on the issue data and the real-time electric vehicle-related data. Through this, monitoring for the electric vehicle 300 may be performed, and based on the issue event, a real-time or periodic warning or notification may be provided. In addition, when an issue event that falls within a significant risk range occurs during an issue event, automatic locking of the electric vehicle 300 may be performed, which will be described below.

As an example, referring to FIG. 5B, a vehicle state may be detected based on the electric vehicle-related information acquired from the cloud 420 based on the at least one piece of extracted issue data, and vehicle state data may be transmitted and monitored. Here, the monitoring-based data may be stored again as vehicle data, and a notification or warning for the issue event may be transmitted to a device corresponding to a driver 513 based on the above-described issue event.

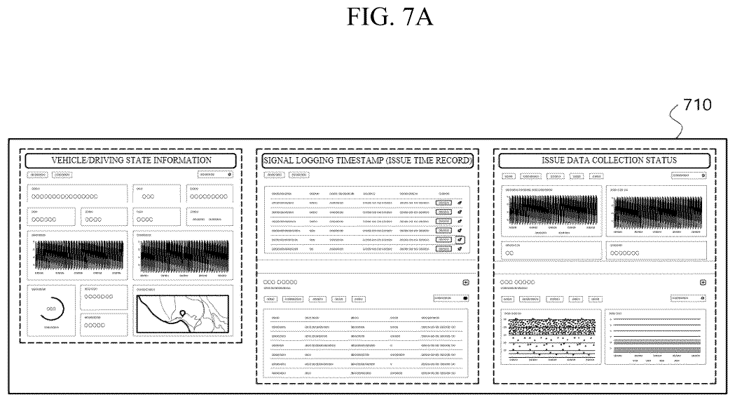

FIG. 6 is a diagram illustrating a method of providing a comprehensive electric mobility control solution. As an example, the key devices of the electrical vehicle such as the EPCU 301, the OBC 302, the drive motor 303, the deceleration device 304, and the BMS 305 may be diagnosed and managed.

Here, as an example, diagnosis and management for each of a plurality of electrical vehicles may be performed through a comprehensive electric mobility control system (or a server) 620. As a specific example, the comprehensive electric mobility control system 620 may manage a plurality of electrical vehicles 611, 612, 613, 614, 615, and 616 with one server or system. Here, each of the plurality of electrical vehicles 611, 612, 613, 614, 615, and 616 may be managed by collecting data on the electric vehicle key devices and monitoring issue events based on the above-described diagnosis solution. Hereinafter, for convenience of description, an electric vehicle including the diagnosis solution will be referred to as a fleet. However, this is only for convenience of description and may not be limited to the corresponding name.

For example, in the case of a privately owned electrical vehicle, electric vehicle diagnosis-related information may be transmitted to a driver or a user based on FIGS. 1 to 5 described above, an issue event may be monitored, and a notification or warning may be transmitted to the driver or the user. On the other hand, there may be a need for a device or method for managing fleets as a plurality of electric vehicles, such as buses or trucks, provided with the diagnosis solution. The comprehensive electric mobility control system 620 may be a server or a system for managing multiple fleets provided with the diagnosis solution, thereby increasing management efficiency for each electrical vehicle.

Referring to FIG. 6, the comprehensive electric mobility control system 620 may obtain electric vehicle-related data by linking with each of the plurality of fleets 611, 612, 613, 614, 615, and 616. As another example, the comprehensive electric mobility control system 620 may be linked with the cloud 420. The cloud 420 may be linked with each of the plurality of fleets 611, 612, 613, 614, 615, and 616 to obtain electrical vehicle-related data, and information regarding the electrical vehicle-related data may be transmitted to the comprehensive electric mobility control system 620. However, this is merely an example and may not be limited thereto.

Here, the comprehensive electric mobility control system 620 may generate fleet-related information based on the obtained electric vehicle related information. The fleet-related information may include information regarding each of the plurality of fleets 611, 612, 613, 614, 615, and 616 and information regarding all the plurality of fleets 611, 612, 613, 614, 615, and 616. As an example, the information regarding each of the plurality of fleets 611, 612, 613, 614, 615, and 616 may include information related to a current location, driving information, issue event information, fleet component-related information, fleet current value information of an individual fleet, and other information related to the fleet, but may not be limited thereto.

As an example, the comprehensive electric mobility control system 620 may display fleet-related information through a dashboard screen based on an Internet-based web or application, but may not be limited thereto. In addition, the information regarding all the plurality of fleets 611, 612, 613, 614, 615, and 616 may include distribution information of fleets, operational information of fleets, management information of fleets, and other information regarding the fleets. As an example, information regarding all the plurality of fleets 611, 612, 613, 614, 615, and 616 may be generated based on average information based on the mileage of the fleets or other information. That is, the comprehensive electric mobility control system 620 may manage not only information regarding the individual fleet, but may also manage overall information considering a relationship among the plurality of fleets 611, 612, 613, 614, 615, and 616. That is, the comprehensive electric mobility control system 620 may include and manage both information regarding each of the plurality of fleets 611, 612, 613, 614, 615, and 616 and the overall information.

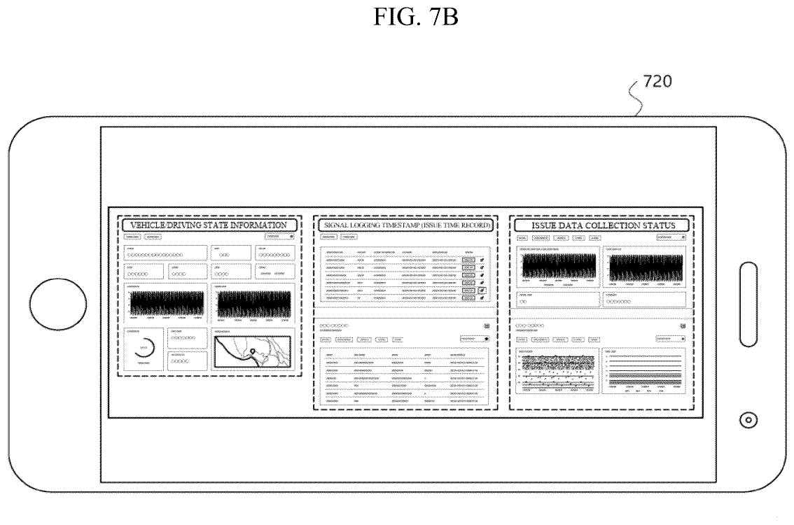

As an example, FIGS. 7A and 7B are diagrams illustrating a method of controlling each fleet-related information based on a comprehensive electric mobility control system according to an embodiment of the present invention. Referring to FIGS. 7A and 7B, the comprehensive electric mobility control system 620 may generate fleet-related information for each individual fleet and provide the fleet-related information to each individual fleet. The individual fleet may display fleet-related information obtained through the comprehensive electric mobility control system 620 through a dashboard 710 or a user device 720.

For example, the fleet-related information may include vehicle information, driving state information, and other information regarding the corresponding fleet. In addition, the fleet-related information may include information regarding a record of data obtained based on signal logging from the EPCU 301, the OBC 302, the drive motor 303, the deceleration device 304, and the BMS 305 as the key devices of the electric vehicle 300.

As a specific example, signal logging time stamp information may be included, but is not limited thereto. In addition, the fleet-related information may further include not only signal logging-related information but also existing OBD-related information, but is not limited to a specific form., That is, the fleet-related information may include vehicle information and driving state information as well as diagnosis-related information within the fleet.

In addition, the fleet-related information may include issue data-related information. Here, the issue data may be information regarding an issue event generated from issue modeling based on the above-described electric vehicle related data. As an example, the issue data extracted based on the issue modeling may be compared with electric vehicle related data obtained in real time to determine whether an issue event occurs, and the corresponding information may be provided to the user in the form of a warning or notification. Here, the fleet-related information may include the above-described issue data-related information. As a specific example, the fleet-related information may include information regarding a record of an issue event that occurs for the corresponding fleet as issue data collection status information. Through this, each fleet may be allowed to check what the current vehicle state is, as well as ensure that the corresponding information is managed through the comprehensive electric mobility control system 620.

Here, the comprehensive electric mobility control system 620 may generate a fleet report as a periodic issue data report of the fleet. For example, the periodicity may be set to daily, weekly, monthly, yearly, and other periods, and may not be limited to a specific form.

The comprehensive electric mobility control system 620 may generate a fleet report including fleet-related information on the basis of a preset period and transmit the fleet report to each fleet or to a device for managing the comprehensive electric mobility control system 620.

As another example, a fleet report including big data information regarding the EPCU 301, the OBC 302, the drive motor 303, the deceleration device 304, and the BMS 305 as the key devices of the electric vehicle 300 based on the fleet-related information may be transmitted to an OEM server. Here, the OEM server may be a server manufactured by the company manufacturing or producing key devices in each fleet, but may not be limited to a specific form. That is, the OEM server may be a server related to key devices in each fleet and will be referred to as an OEM server for convenience of description.

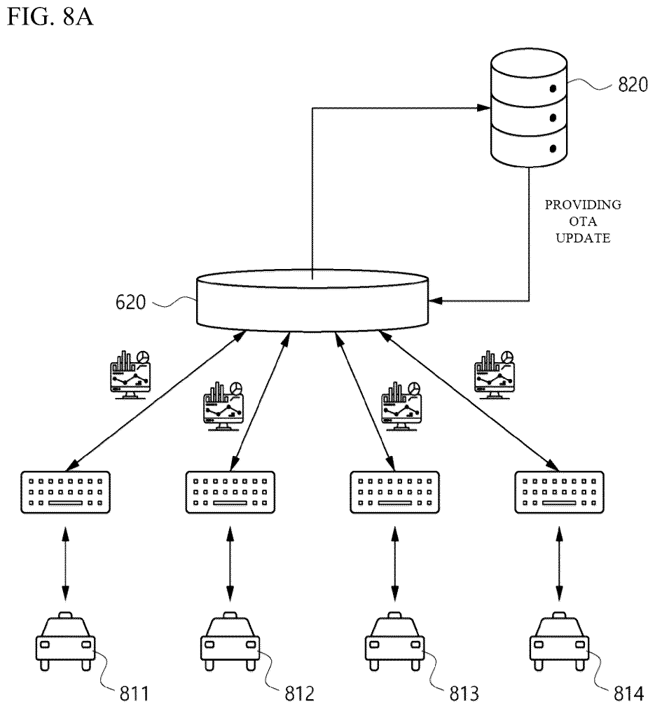

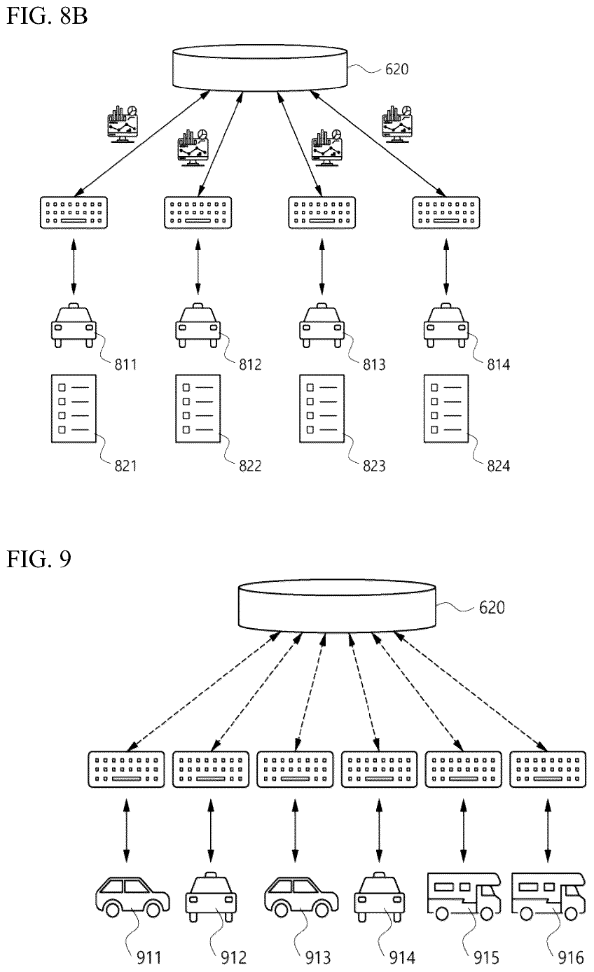

As an example, FIGS. 8A and 8B are diagrams illustrating data exchange between a comprehensive electric mobility control system and an OEM server according to an embodiment of the present invention. Referring to FIG. 8A, the comprehensive electric mobility control system 620 may provide a fleet report including big data information regarding the key device to the OEM server.

That is, the comprehensive electric mobility control system 620 may provide big data for the electric vehicle key device to the OEM server 820. In this case, an OTA update may be required from the OEM server 820 based on the big data for the electric vehicle key device. As a specific example, the OEM server 820 may check a software or hardware configuration that requires improvement based on big data for the electric vehicle key device and update the software or hardware configuration.

Here, conventionally, it is necessary for the OEM server 820 to communicate with each fleet and provide update information after a fleet-to-OTA connection. On the other hand, in FIG. 8A, when the OTA update is performed based on the provided fleet report, the comprehensive electric mobility control system 620 may directly obtain the update information from the OEM server 820. Thereafter, the comprehensive electric mobility control system 620 may transmit the update information to each of fleets 811, 812, 813, and 814 linked therewith, and the fleet may quickly update the OTA after the OTA connection.

That is, the comprehensive electric mobility control system 620 may control not only signal logging-related information regarding the EPCU 301, the OBC 302, the drive motor 303, the deceleration device 304, and the BMS 305 as the key devices of the electric vehicle 300 described above, but also OBD and OTA-related information to be linked with each fleet, thereby increasing management efficiency.

In addition, as an example, referring to FIG. 8B, the comprehensive electric mobility control system 620 may generate and manage key device information, component-related information, and current value information regarding each of the fleets 811, 812, 813, and 814. As an example, the key device information, the component-related information, and the current value information may be included in the above-described fleet-related information. That is, the comprehensive electric mobility control system 620 may obtain and manage information for managing key devices or other components for each of the fleets 811, 812, 813, and 814. In addition, the comprehensive electric mobility control system 620 may generate and manage current value information regarding each of the fleets 811, 812, 813, and 814. Here, the comprehensive electric mobility control system 620 may control driving or operating of the plurality of fleets 811, 812, 813, and 814 based on the above-described information.

More specifically, the comprehensive electric mobility control system 620 may obtain consumable or other component-related information for each of the fleets 811, 812, 813, and 814 to manage the component replacement cycle of the fleet or other information. Through this, each of the fleets 811, 812, 813, and 814 may be managed in an integrated manner without being managed individually, thereby increasing management efficiency. In addition, issue management for the key device may be performed in each of the fleets 811, 812, 813, and 814.

As an example, the comprehensive electric mobility control system 620 may obtain key device issue information regarding each of the fleets 811, 812, 813, and 814 and provide information to increase the electric vehicle operating time or increase the electric vehicle component life, based on the obtained information. As a specific example, the comprehensive electric mobility control system 620 may control a charging time or a charging point in time based on key component information of a specific fleet, but is not limited to a specific embodiment. As another example, the comprehensive electric mobility control system 620 may obtain all the issue information of the plurality of fleets 811, 812, 813, and 814 to provide related information, and control each of the fleets 811, 812, 813, and 814.

As an example, the comprehensive electric mobility control system 620 may control the scheduling for a charging place and charging time for each of the fleets 811, 812, 813, and 814 based on big data information in consideration of the limited charging place and time, thereby increasing fleet management efficiency. In addition, the comprehensive electric mobility control system 620 may generate current value information of each of the fleets 811, 812, 813, and 814, and control each of the fleets 811, 812, 813, and 814 based on the current value information, thereby increasing management efficiency.

As another example, the comprehensive electric mobility control system 620 may manage fleet-based data in consideration of the type of fleet to be linked. As a specific example, fleets 911, 912, 913, 914, 915, and 916 linked to the comprehensive electric mobility control system 620 may be classified by type. For example, types of fleets 911, 912, 913, 914, 915, and 916 may be distinguished by vehicle type. As another example, the types of fleets 911, 912, 913, 914, 915, and 916 may be distinguished based on a manufacturing date. As another example, the types of the fleets 911, 912, 913, 914, 915, and 916 may be distinguished based on the mileage or current value information of the fleet, but are not limited to a specific embodiment.

That is, even though the comprehensive electric mobility control system 620 manages a plurality of fleets 911, 912, 913, 914, 915, and 916, there is a need to control each of the fleets 911, 912, 913, 914, 915, and 916 differently based on their current state or characteristics. In consideration of the matters described above, the comprehensive electric mobility control system 620 may generate and manage fleet-based data in consideration of the types of the fleets 911, 912, 913, 914, 915, and 916, thereby increasing management efficiency.

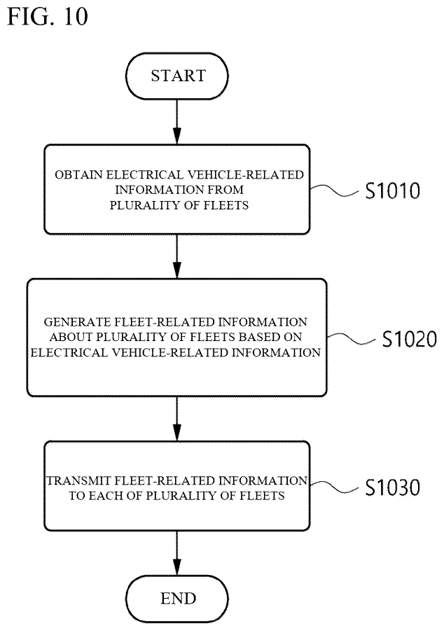

FIG. 10 is a flowchart illustrating a method of providing a comprehensive electric mobility control solution according to an embodiment of the present invention. Referring to FIG. 10, a device for providing a comprehensive electric mobility integrated control solution may obtain electrical vehicle-related information from a plurality of fleets (S1010).

Thereafter, the device for providing the comprehensive electric mobility control solution may generate fleet-related information regarding a plurality of fleets based on the electrical vehicle-related information (S1020) and transmit the fleet-related information to each of the plurality of fleets (S1030). Here, the fleet-related information is transmitted to each of the plurality of fleets based on a web or application, and each of the plurality of fleets may display the received fleet-related information through a dashboard or a display unit.

As an example, the device for providing the comprehensive electric mobility control solution may be the above-described comprehensive electric mobility control system (or server). As an example, the device for providing comprehensive electric mobility control solution may include a transceiver that transmits and receives data, a memory that stores data, and a control unit that controls the transceiver and the memory.

That is, the device for providing comprehensive electric mobility control solution may serve as a system or a server, as the computing device of FIG. 2. For example, the device for providing comprehensive electric mobility control solution may generate a fleet report for each of a plurality of fleets and transmit the generated fleet report to an OEM server. Thereafter, the device for providing comprehensive electric mobility control solution may obtain OTA update information from the OEM server and transmit the OTA update information to each of the plurality of fleets. Through this, the plurality of fleets may update their OTA software based on the OTA update information.

Here, the fleet-related information may include information regarding each of a plurality of fleets and information regarding all the plurality of fleets. As an example, the information regarding each of the plurality of fleets includes current location information of the fleet, driving information of the fleet, issue event information of the fleet, fleet component-related information, and fleet current value information, and the information regarding all the plurality of fleets may include distribution information of the fleets, operational information of the fleets, and management information of the fleets.

Here, the fleet-related information generated based on the electric vehicle related information may further include key device information, component-related information, and fleet current value information regarding each of the plurality of fleets. In addition, the device for providing comprehensive electric mobility control solution may control driving of each of the plurality of fleets based on the key device information, the component-related information, and the fleet current value information regarding each of the plurality of fleets. In addition, as an example, the fleet-related information generated based on the electric vehicle-related information may be generated in consideration of the type of each of the plurality of fleets.

As another example, each of the plurality of fleets may obtain data from a data scanning device of each of one or more fleet key devices, acquire selected compressed data through a DB constructed from the data, transmit the selected compressed data and OBD-based data to a cloud, extract issue data through issue modeling based on electric vehicle-related data, which includes the selected compressed data and the OBD-based data, set an issue event through the extracted issue data, and provide a real-time notification and warning based on the issue event.

In addition, the one or more fleet key devices may include an EPCU, an OBC, a drive motor, a deceleration device, and a BMS, and the data scanning device may include a sensor, an edge computing module, and a communication module. In addition, the data obtained from the data scanning device of each of the one or more fleet key devices may include power, current, voltage, vibration, noise, and other data, and the selected compressed data may be generated by comparing a waveform and trimmed data obtained from the data with the constructed DB.

In addition, one or more issue events may be set through the issue modeling based on the extracted issue data. Here, the issue event may include a first threshold value for issue event triggering, the issue event may provide real-time electrical vehicle related information for the issue event when a difference value between electric vehicle-related information obtained in real time from the cloud and the extracted issue event is compared with the first threshold value and the comparison result is greater than the first threshold value.

The above-described embodiments may be implemented at least partially as a computer program and recorded on a computer-readable recording medium. A computer-readable recording medium on which a program for implementing the embodiments is recorded includes all kinds of recording devices on which data readable by a computer is stored. Examples of the computer-readable recording medium include a ROM, a RAM), a CD-ROM, magnetic tape, an optical data storage device, and the like. In addition, the computer-readable recording medium may also be distributed over network-connected computer systems so that computer-readable code is stored and executed in a distributed manner. In addition, functional programs, codes, and code segments for implementing the present embodiments may be easily understood by a person skilled in the art to which the present embodiments belong.

Although the present invention has been described with reference to the embodiments shown in the drawings, these are merely exemplary, and those skilled in the art will understand that various modifications and variations can be made therefrom. However, such modifications should be considered to be within the scope of technical protection of the present invention. Accordingly, the true technical protection scope of the present invention should be determined to include other implementations, other embodiments, and equivalents to the claims by the technical idea of the appended claims.

1. A method of providing a comprehensive electric mobility control solution, comprising:
obtaining electric mobility-related information from a plurality of fleets;
generating, on the basis of the electric mobility-related information, fleet-related information regarding the plurality of fleets; and
transmitting the fleet-related information to each of the plurality of fleets,
wherein, on the basis of a web or application, the fleet-related information is transmitted to each of the plurality of fleets, and each of the plurality of fleets displays the received fleet-related information through a dashboard or display unit.

2. The method of claim 1, further comprising:
generating a fleet report for each of the plurality of fleets;
transmitting the generated fleet report to an original equipment manufacturer (OEM) server;
obtaining over-the-air (OTA) update information from the OEM server; and
transmitting the OTA update information to each of the plurality of fleets,
wherein the plurality of fleets update OTA software included therein based on the OTA update information.

3. The method of claim 1, wherein the fleet-related information includes information regarding each of the plurality of fleets and information regarding all the plurality of fleets,
the information regarding each of the plurality of fleets includes current location information of the fleet, driving information of the fleet, issue event information of the fleet, fleet component-related information, and fleet current value information, and
the information regarding all the plurality of fleets includes distribution information of the fleets, operational information of the fleets, and management information of the fleets.

4. The method of claim 1, wherein the fleet-related information generated based on the electric mobility-related information further includes key device information, component-related information, and fleet current value information regarding each of the plurality of fleets, and
driving of each of the plurality of fleets is controlled based on the key device information, the component-related information, and the fleet current value information regarding each of the plurality of fleets.

5. The method of claim 1, wherein the fleet-related information generated based on the electric mobility-related information is generated in consideration of a type of each of the plurality of fleets.

6. The method of claim 1, wherein each of the plurality of fleets is configured to:
obtain data from a data scanning device of each of one or more fleet key devices;
obtain selected compressed data through a database (DB) constructed from the data;
transmit the selected compressed data and on-board diagnostics (OBD)-based data to a cloud;
extract issue data through issue modeling based on the electric mobility-related information, which includes the selected compressed data and the OBD-based data;
set an issue event through the extracted issue data; and
provide a real-time notification and warning based on the issue event.

7. The method of claim 6, wherein the fleet key device includes at least one of an integrated electric power control unit (EPCU), an on-board charger (OBC), a drive motor, a deceleration device, and a battery management system (BMS), and
the data scanning device includes at least one of a sensor, an edge computing module, and a communication module.

8. The method of claim 7, wherein the data obtained from the data scanning device of each fleet key device includes at least one of power, current, voltage, vibration, noise, and other data, and
the selected compressed data is generated by comparing a waveform and trimmed data obtained from the data with the constructed DB.

9. The method of claim 6, wherein one or more issue events are set through the issue modeling based on the extracted issue data, the issue events include a first threshold value for issue event triggering, and the issue events provide the real-time notification and warning for the issue events when a difference value between real-time electric mobility-related information obtained in real time from the cloud and the extracted issue event is compared with the first threshold value and a comparison result is greater than the first threshold value.

10. A computer program stored in a computer-readable recording medium to execute the method according to claim 1 in combination with hardware.

11. A device for providing a comprehensive electric mobility control solution, comprising:
a transceiver that transmits and receives data;
a memory that stores the data; and
a control unit that controls the transceiver and the memory,
wherein the control unit obtains electric mobility-related information from a plurality of fleets, generates, on the basis of the electric mobility-related information, fleet-related information regarding the plurality of fleets, and transmits the fleet-related information to each of the plurality of fleets, and
the fleet-related information is transmitted to each of the plurality of fleets on the basis of a web or application, and each of the plurality of fleets displays the received fleet-related information through a dashboard or display unit.
